(19) United States
(12) Patent Application Publication
(10) Pub. No.: US 2020/0326243 A1
(43) Pub. Date: Oct. 15, 2020

(54) OPTICAL FLAME-SENSOR

(71) Applicant: ONPOINT TECHNOLOGIES, LLC, Wichita, KS (US)

(72) Inventors: Charlie Callahan, Norwell, MA (US); Andrew Sappey, Lakewood, CO (US); Tristan Stelzner, Evanston, IL (US)

(21) Appl. No.: 16/846,448

(22) Filed: Apr. 13, 2020

Related U.S. Application Data
(60) Provisional application No. 62/833,854, filed on Apr. 15, 2019.

(51) Int. Cl. G01K 11/32; F23N 5/24

(52) U.S. Cl. CPC G01K 11/3206; F23N 2229/18; F23N 5/245

(57) ABSTRACT

An optical flame-sensor includes an optical circulator, an optical-fiber cavity, and a first optical sensor. The optical circulator includes a first port, a second port, and a third port. The first port is configured to receive an optical signal. The second port is configured to output the optical signal received at the first port. The third port is configured to output the input to the second port. The optical-fiber cavity includes a cavity proximal-end optically coupled to the second port, and a mirror at a cavity distal-end, such that a cavity optical signal output by the optical-fiber cavity is the input to the second port. The first optical sensor is optically coupled to the third port to quantify the cavity optical signal.

### CROSS REFERENCE TO RELATED APPLICATIONS

This application is based on U.S. Provisional Patent Application No. 62/833,854, filed Apr. 15, 2019. The priority of the foregoing application is hereby claimed, and the disclosure incorporated herein by reference in its entirety.

### BACKGROUND

Burners operate within a furnace to generate thermal energy via fuel combustion. Depending on the application, a furnace can include one to many burners. When operating properly, furnaces produce a flame by continuously burning gas emitted from a gas valve. To prevent gas leaks and associated hazards, furnaces are configured to close the gas valve when the flame is not present. For this purpose, furnace burners include a flame sensor fitted in a flame-sensor port of the burner housing. Common flame sensors operate via flame rectification include a metal rod with an AC voltage applied thereto. See, for example, U.S. Pat. No. 4,427,363 to Hammond. The metal rod is grounded at its proximal end, away from the flame at the burner housing for example, and is configured such that when a flame is present, the rod's distal end is in the flame. The AC voltage ionizes molecules in the flame. The ionized molecules produce a DC current in the metal rod, which is detected by the flame sensor. Due to the harsh environment in which these flame sensors operate, such flame sensors are prone to ground faults that cause them to fail.

### SUMMARY OF THE EMBODIMENTS

In a first aspect, an optical flame-sensor includes an optical circulator, an optical-fiber cavity, and a first optical sensor. The optical circulator includes a first port, a second port, and a third port. The first port is configured to receive an optical signal. The second port is configured to output the optical signal received at the first port. The third port is configured to output the input to the second port. The optical-fiber cavity includes a cavity proximal-end optically coupled to the second port, and a mirror at a cavity distal-end, such that a cavity optical signal output by the optical-fiber cavity is the input to the second port. The first optical sensor is optically coupled to the third port and configured to quantify the cavity optical signal.

In certain embodiments of the first aspect, a laser is configured to generate the optical signal.

In certain embodiments of the first aspect, a signal generator electrically coupled to the laser and configured to apply a periodic waveform to the laser.

In certain embodiments of the first aspect, the laser is a distributed feedback laser configured to be tuned by the periodic waveform.

In certain embodiments of the first aspect, the optical-fiber cavity has, at the cavity proximal-end, a return loss between three and five percent.

In certain embodiments of the first aspect, the optical flame-sensor further includes a first optical fiber optically coupling the optical-fiber cavity to the second port via an angle-polished optical-fiber connector.

In certain embodiments of the first aspect, the optical-fiber cavity includes a metalized optical fiber.

In certain embodiments of the first aspect, the optical-fiber cavity includes an optical-fiber core formed of a first material having a refractive index n₁. The mirror includes a reflective surface formed of a second material having a refractive index n_{R}, (n_{R}−n₁)≥0.2.

In certain embodiments of the first aspect, the second material is selected from the group consisting of silicon, alumina, and zinc oxide.

In certain embodiments of the first aspect, the optical flame-sensor further comprises a reference optical sensor.

In certain embodiments of the first aspect, the optical flame-sensor further comprises a fiber-optic coupler including (i) a first coupler output optically coupling a first percentage of the optical signal to the first port, and (ii) second coupler output optically coupling a reference optical signal to the reference optical sensor.

In certain embodiments of the first aspect, the reference optical signal is a second percentage of the optical signal, the reference optical sensor is configured to quantify the reference optical signal, and the first percentage exceeds the second percentage.

In certain embodiments of the first aspect, the optical flame-sensor further comprises a processor; and a memory configured to store the quantified cavity optical signal and machine-readable instructions that, when executed by the processor, control the processor to: analyze the quantified cavity optical signal to determine whether the optical-fiber cavity is heating or cooling according to at least one of (i) a temporal change in interference fringes of the cavity optical signal and (ii) a change in a number of detected interference fringes of the cavity optical signal during a modulation period of an optical signal.

In certain embodiments of the first aspect, the optical signal has a center wavelength λ₀. In certain embodiments of the first aspect, the mirror has, at center wavelength λ₀, (i) a refractive index n₁ and thickness L₁ at a first temperature T₁ and (ii) a refractive index n₂ and thickness L₂ at a second temperature T₂, such that L₁¼λ₀/n_{R1} (2q₁+1) and L₂=½λ₀/n_{R2} (2q₂+1), q₁ and q₂ being non-negative integers and |T₂−T₁|>500 K.

In certain embodiments of the first aspect, the memory further stores machine-readable instructions that, when executed by the processor, control the processor to: extract a carrier signal from the quantified cavity optical signal by applying a low-pass filter thereto, and determine a temperature range of the optical-fiber cavity according to a shape of the carrier signal, which is determined in part by a temperature-dependent reflectivity of the mirror.

In certain embodiments of the first aspect, the optical-fiber cavity includes an optical fiber, the mirror being a distal end of the optical fiber that defines the cavity distal-end.

In a second aspect, an optical flame-sensor includes an optical circulator, a first optical fiber, a mirror, and a first optical sensor. The optical circulator includes a first port, a second port, and a third port. The first port is configured to receive an optical signal having a center wavelength λ₀. The second port is configured to output the optical signal received at the first port. The third port is configured to output the input to the second port. The first optical fiber includes (i) a proximal end optically coupled to the second port and (ii) a distal end. The mirror is coupled with the distal end and is configured to reflect light emerging from the distal end back toward the proximal end. The mirror has, at center wavelength λ₀, (i) a refractive index n_{R1} and thickness L₁ at a first temperature T₁ and (ii) a refractive index n_{R2} and thickness L₂ at a second temperature T₂, such that L₁¼λ₀/4n_{R1} (2q₁+1) and L₂½λ₀/2n_{R2} (2q₂+1), q₁ and q₂ are non-negative integers and |T₂−T₁|>500 K. The first optical sensor is optically coupled to the third port and is configured to quantify a reflected optical signal output by the proximal end.

In a third aspect, an optical flame-sensor includes and an optical-fiber cavity and a housing. The optical-fiber cavity includes a cavity distal-end, a mirror at the cavity distal-end, and a cavity proximal-end configured to optically couple to (i) a laser and (ii) an optical sensor. The housing is configured to mount the optical-fiber cavity to a flame-sensor port of a burner.

In certain embodiments of the third aspect, the housing is configured to replace a flame-rectification-based flame sensor without modification to the burner.

In a fourth aspect, a method for detecting presence of a flame includes: (i) periodically modulating a wavelength of an optical signal generated by a laser to produce a modulated signal and (ii) detecting a cavity optical signal output by an optical-fiber cavity coupled to the laser. The cavity optical signal includes an amplitude modulation determined according to when the wavelength of the optical signal corresponds to a mode of the optical-fiber cavity. The method also includes determining whether the optical-fiber cavity is heating or cooling according to a time-dependence of the amplitude modulation.

In certain embodiments of the fourth aspect, the method further comprises extracting a carrier signal from the cavity optical signal by applying a low-pass filter thereto; and determining a temperature range of the optical-fiber cavity according to a shape of the carrier signal.

In certain embodiments of the fourth aspect, determining a temperature range of the optical-fiber cavity comprises tracking a phase of a frequency-domain representation of the amplitude modulation.

In certain embodiments of the fourth aspect, the determining a temperature range of the optical-fiber cavity comprises converting the amplitude modulation to a binary time-series; and tracking, during a time-interval of the binary time-series not exceeding a time duration between consecutive modes of the optical-fiber cavity, when the binary time-series transitions from a first discrete value and a second discrete value.

In a fifth aspect, a method for detecting presence of a flame includes coupling an optical signal generated by a laser into a proximal end of an optical fiber having a mirror at a distal end thereof. The mirror has a predetermined temperature-dependent reflectivity. The method also includes detecting optical power of an output optical signal reflected by the mirror; determining a reflectivity of the mirror from the detected optical power; and determining a temperature of the mirror by mapping the determined reflectivity to the predetermined temperature-dependent reflectivity.

Any of the above described aspects may be combined together such that one aspect may include one or more components of another aspect. Where a system aspect is combined with a method aspect, the system may include a processor and memory storing machine-readable instructions that when executed by the processor implement the steps described in the method aspect.

### BRIEF DESCRIPTION OF THE FIGURES

FIG. 1 is a schematic of an optical flame-sensor, in an embodiment.

FIG. 2 includes plots illustrating data measured by an embodiment of optical flame-sensor of FIG. 1, where a mirror thereof has a fifty-percent reflectivity.

FIG. 3 includes a plot illustrating data measured by an embodiment of optical flame-sensor of FIG. 1, where a mirror thereof has an eight-percent reflectivity.

FIG. 4 includes a plot illustrating data measured by an embodiment of optical flame-sensor of FIG. 1, where a mirror thereof has a fifty-percent reflectivity.

FIG. 5 is a flowchart illustrating a first method for detecting presence of a flame, in an embodiment.

FIG. 6 is a flowchart illustrating a second method for detecting presence of a flame, in an embodiment.

FIG. 7 is a graphical representation of a signal that is processed and stored by the optical flame-sensor of FIG. 1, in an embodiment.

FIG. 8 is a graphical representation of a filtered signal that results from filtering the signal of FIG. 7, in an embodiment.

FIG. 9 is a pseudocolor plot representing a time-evolution of a binary signal derived from the filtered signal of FIG. 8, in an embodiment.

FIG. 10 is a graphical depiction of a half-sawtooth voltage that modulates a wavelength of a laser of the optical flame-sensor of FIG. 1, in an embodiment.

FIG. 11 is a graphical depiction of a cavity electrical signal resulting from the half-sawtooth voltage of the embodiment of FIG. 10.

FIG. 12 is a schematic block diagram of a multichannel furnace-flame monitor, which includes a plurality of optical flame-sensors of FIG. 1 each monitoring a respective furnace flame, in an embodiment.

### DETAILED DESCRIPTION OF THE EMBODIMENTS

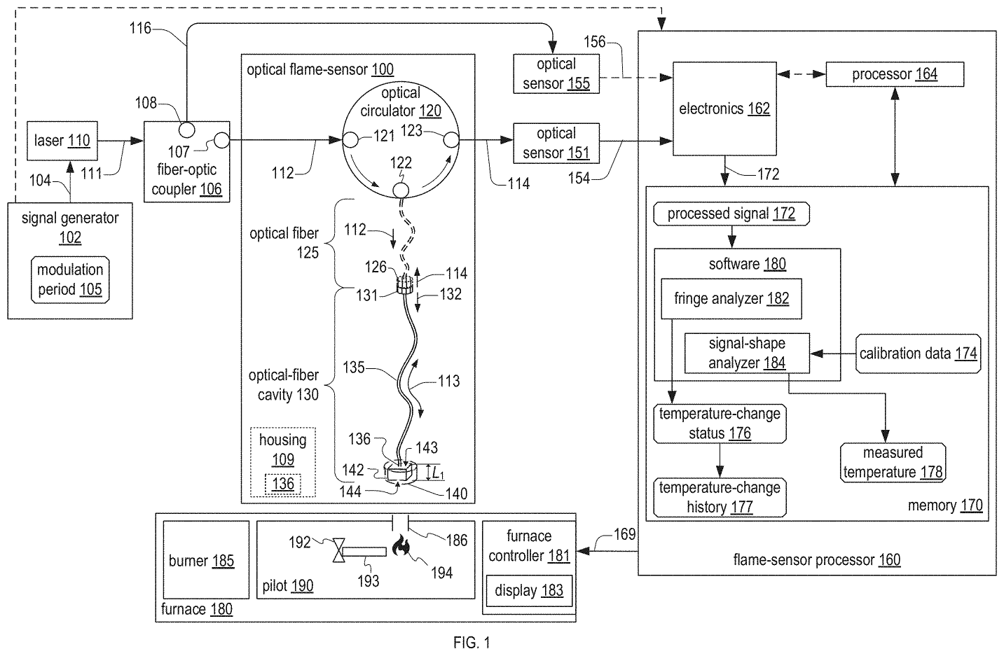

FIG. 1 is a schematic of an optical flame-sensor 100 near a burner 185 of furnace 180. Furnace 180 includes a pilot 190, which includes a gas valve 192 and a pilot tip 193. Gas valve 192 is configured to control emission of fuel from pilot tip 193.When burned, the emitted fuel forms a flame 194. When furnace 180 includes a plurality of burners 185, each burner 185 may have a respective pilot 190. Alternatively, furnace 180 may include more burners 185 than pilots 190, such that a single pilot 190 is associated with more than one burner 185. Pilot 190 may be attached to burner 185, for example, to a front plate of burner 185.

Furnace 180 includes a flame-sensor port 186. In embodiments, flame-sensor port 186 is a port of burner 185, in a back plate thereof for example. In embodiments flame-sensor port 186 is a port of pilot 190, such that a flame sensor can be inserted into pilot 190. Flame-sensor port 186 may be a conventional flame-sensor port configured to receive non-optical flame-sensors, such as those based on flame rectification described above.

Optical flame-sensor 100 includes an optical-fiber cavity 130. In embodiments, optical flame-sensor 100 also includes at least one of a signal generator 102, a laser 110, an optical circulator 120, an optical sensor 151, and a flame-sensor processor 160. In certain embodiments, optical sensor 151 is an InGaAs photodiode detector. In embodiments, flame-sensor processor 160 is communicatively coupled to a furnace controller 181 of furnace 180 such that when flame-sensor processor 160 determines that flame 194 has extinguished, flame-sensor processor 160 transmits a signal 169 to furnace controller 181. In response to receiving signal 169, furnace controller 181 controls gas valve 192. In embodiments, in addition to or alternatively from closing gas valve 192, furnace controller 181, in response to receiving signal 169, displays an indication or alert on a display 183 in electrical communication with furnace controller 181. Display 183 may be part of a main control board for furnace 180, or may be wirelessly coupled to furnace controller 181, such as a handheld device used by operators and technicians of furnace 180.

In embodiments, flame-sensor processor 160 is an integral component of furnace controller 181. Furnace controller 181 may control multiple burners 190 within a given furnace, or multiple furnaces, depending on the application. Alternatively, or in addition, flame-sensor processor 160 may be coupled to another external device (not shown), such as a furnace management system, and configured to transmit an alert to the burner management system indicating presence or absence of flame 194.

In embodiments, one or more components of optical flame-sensor 100 are configured to be removable for easy replacement. For example, in embodiments, optical-fiber cavity 130 is a standalone, replaceable component of optical flame-sensor 100 wherein replacement thereof does not require replacement of laser 110, fiber-optic coupler 106, and 107, optical circulator 120, optical sensors 151, 155, and components of the flame-sensor processor 160.

Optical circulator 120 includes a first port 121, a second port 122, and a third port 133. First port 121 is configured to receive an optical signal, such as an optical signal 112. Second port 122 is configured to output optical signal 112 received at first port 121. Third port 133 is configured to output the input to second port 122.

Optical-fiber cavity 130 includes a cavity proximal-end 131, an optical fiber 135, and a mirror 140 at a distal end 136 of optical fiber 135. Cavity proximal-end 131 is optically coupled to second port 122 such that it receives optical signal 112. Optical-fiber cavity 130 sustains a cavity signal 113 therein. Part of cavity signal 113 exits cavity proximal-end 131 as a cavity output signal 114. Cavity output signal 114 output by optical-fiber cavity 130 is the input to second port 122. Optical sensor 151 is optically coupled to third port 123 to detect cavity output signal 114 and generate therefrom a cavity electrical signal 154. Mirror 140 is attached to optical fiber 135 and may enclose distal end 136 thereof. An advantage of mirror 140's being part of optical fiber cavity 130 (e.g., as a layer deposited thereon for example) is its enabling optical fiber cavity to be a modular component of optical flame sensor 100 that is easily replaceable.

Signal generator 102 is electrically coupled to laser 110 and is configured to apply a time-varying voltage 104 to laser 110. Laser 110 is configured to generate an optical signal 111. Optical signal 112 includes at least part of optical signal 111.

In embodiments, laser 110 is a diode laser, such as distributed feedback laser, a distributed Bragg reflector laser, or a vertical-cavity surface-emitting laser. In embodiments, laser 110 includes a InGaAsP laser diode. Optical signal 111 has a center wavelength λ₀, which may be a visible wavelength or near-IR wavelength, such as a wavelength between 1.2 μm and 1.70 μm.

In embodiments, laser 110 is configured to be tuned by time-varying voltage 104, such that time-varying voltage 104 periodically modulates the wavelength of optical signal 111 at a modulation period 105. Laser 110 is electrically connected to signal generator 102 such that time-varying voltage 104 modulates the current applied thereto, e.g., to the laser diode. Increasing the current causes center wavelength λ₀ to increase, while decreasing the current causes center wavelength λ₀ to decrease. In embodiments, time-varying voltage 104 is periodic and has a frequency between 5 kHz and 15 kHz, such as 10 kHz, and may be sinusoidal, or non-sinusoidal, such as sawtooth waveform or a triangle waveform. In embodiments, time-varying voltage 104 implements other frequencies less than 5 kHz or greater than 15 kHz. Time-varying voltage 104 has an amplitude sufficient to modulate center wavelength λ₀ by ±δλ. In embodiments where laser 110 is a distributed feedback laser, δλ may be between 0.2 nm and 0.4 nm. Optical fiber 135 and any other optical fiber disclosed herein in may be a single-mode optical fiber at center wavelength λ₀.

FIG. 1 denotes a reflectance 132 at cavity proximal-end 131 of light incident thereon from optical fiber cavity 130. In embodiments, reflectance 132 is between three to five percent at center wavelength λ₀. This range of reflectance far exceeds losses for physical contact (“PC”) fiber couplings, and increases the amplitude of interference maxima of cavity output signal 114 (and the contrast of interference fringes), and hence facilitates determination of whether flame 194 is present or absent.

In embodiments, optical flame sensor 100 includes an optical fiber 125 that optically couples optical-fiber cavity 130 to second port 122. Optical fiber 125 has a fiber distal-end 126.

Fiber distal-end 126 and cavity proximal-end 131 may be coupled such that an air gap therebetween increases the amplitude of reflectance 132. In embodiments, fiber distal-end 126 and cavity proximal-end 131 are terminated, e.g. connectorized, with an angled polish (e.g., an APC connector) and a non-angled (flat) polish (e.g., a flat, PC, or UPC connector) respectively, which yields the aforementioned air gap.

In embodiments, fiber distal-end 126 and cavity proximal-end 131 each have flat-polished terminations and are coupled with no air gap therebetween (a PC-to-PC or UPC-to-UPC coupling, for example), which results in reflectance 132 being less than in the aforementioned coupling that includes an air gap. To increase reflectance 132, fiber distal-end 126 may have a reflective coating thereon, such as a dielectric coating. In embodiments, the reflective coating has a reflectance between forty and sixty percent at center wavelength λ₀. A benefit of the reflective coating being on fiber distal-end 126, instead of cavity proximal-end 131, is that replacing optical fiber cavity 130—necessitated by flame-induced wear—does not require replacing the reflective coating.

In embodiments, optical flame-sensor 100 includes a housing 109. Optical fiber 125 may be a single-mode optical fiber at center wavelength λ₀ sufficiently long to facilitate mounting optical-fiber cavity 130, with housing 109 for example, to flame-sensor port 186 such that optical-fiber cavity 130 is sufficiently close to gas valve 192 to detect heat generated by flame 194. Housing 109 may be configured such that cavity distal-end 136 can be secured, e.g., removably secured, within housing 109. In embodiments, housing 109 is configured to mount optical flame-sensor 100 in the same location as a flame-rectification-based flame sensor described above. For example, housing 109 may be configured to mount optical-fiber cavity 130 directly within flame 194, or within a portion of burner 185 that receives excess flame 194, such as a flame detector side tube. Accordingly, the housing 109 is configured such that optical flame-sensor 100 is a retrofit to flame sensor(s) based on rectification described above.

In embodiments, optical fiber 135 is a metalized optical fiber. For example, optical fiber 135 may have a metal coating covering its cladding surface, whereas cladding surfaces of conventional fibers have a polyacrylate coating. The metal may be composed of a metal selected from the group of metals including aluminum, copper, gold, silver, and any combination thereof. Accordingly, the metal may have a melting point exceeding 700° C. such that it does not melt when near or in flame 194. In embodiments, for additional protection, at least part of optical-fiber cavity 130 is inside a protective housing, such as a flexible metal tube or monocoil, which may be formed of steel or other material.

In embodiments, optical flame-sensor 100 includes a fiber-optic coupler 106 and an optical sensor 155, which may be similar or identical to optical sensor 151. Fiber-optic coupler 106 includes a first coupler output 107 that optically couples optical signal 112 to first port 121. In embodiments, fiber-optic coupler also includes a second coupler output 108 that optically couples a reference optical signal 116 to optical sensor 155. Optical signal 112 is a first percentage of optical signal 111. Reference optical signal 116 is second percentage of optical signal 111. The first percentage exceeds the second percentage, in embodiments.

For example, the first percentage is ninety percent and the second percentage is ten percent. Other ratios of the first percentage to the second percentage may be implemented without departing from the scope hereof. Optical sensor 155 generates a reference electrical signal 156 from reference optical signal 116. In embodiments, optical sensor 155 is optically coupled to fiber optic coupler 106 to receive reference optical signal 116. For example, a respective single-mode optical fiber guides optical signal 112 between fiber-optic coupler 106 and first port 121, cavity output signal 114 between third port 123 and optical sensor 151, and reference optical signal 116 between fiber-optic coupler 106 and optical sensor 155.

In embodiments, optical fiber 135 is formed of a first material having a refractive index n₁ at center wavelength λ₀ at a first temperature T₁. First temperature T₁ may be between 15° C. and 30° C., and correspond to a “no flame” temperature when flame 194 is absent. In embodiments, distal end 136 of optical fiber 135 is perpendicular to the optical axis of optical fiber 135. In embodiments, the distal end 136 includes a polished surface.

Reflective properties of mirror 140 may result from the interface of the physical end of optical fiber 135 with an ambient medium, such as air, surrounding this physical end. For example, mirror 140 may be a polished and/or cleaved surface of distal end 136 (e.g., perpendicular to the optical axis of optical fiber 135), such that mirror 140 is part of optical fiber 135. In embodiments, distal end 136 has a reflective coating thereon, and functions as a mirror. In embodiments, mirror 140 is a semiconductor layer, such as a silicon layer, that protects distal end 136 from moisture and other deposits while being sufficiently thin (≤λ₀/10 for example) to prevent interference/etalon effects.

In embodiments, mirror 140 is distinct from optical fiber 135. For example, mirror 140 may include a layer 142 formed of a second material having a refractive index n_{R} and a thickness L₁ at first temperature T₁. Examples of the second material include silicon, alumina, and zinc oxide. Refractive index n_{R} may satisfy (n_{R}−n₁)≥0.2 such that layer 142's reflectivity, determined in part by n_{R} and n₁, results in cavity output signal 114 having modulated interference maxima with amplitudes sufficient for detection by optical sensor 151 and characterization by flame-sensor processor 160.

Flame-sensor processor 160 includes electronics 162, a processor 164, and a memory 170. Processor 164 is communicatively coupled to memory 170 and may be communicatively coupled to electronics 162. Electronics 162 is communicatively coupled to memory 170. Electronics 162 may include one or more of operational amplifier and a microcontroller, and may be a data acquisition device.

Memory 170 may be transitory and/or non-transitory and may include one or both of volatile memory (e.g., SRAM, DRAM, computational RAM, other volatile memory, or any combination thereof) and non-volatile memory (e.g., FLASH, ROM, magnetic media, optical media, other non-volatile memory, or any combination thereof). Part or all of memory 170 may be integrated into processor 164.

Electronics 162 receives cavity electrical signal 154 and, in embodiments, reference electrical signal 156, and produces a processed signal 172 therefrom. For example, electronics 162 produces the processed signal 172 by normalizing cavity electrical signal 154 by reference electrical signal 156 to increase the signal-to-noise ratio of cavity electrical signal 154. In embodiments, processed signal 172 is a digital signal, and electronics 162 includes an analog-to-digital converter(s) to convert reference electrical signal 156 and cavity electrical signal 154 from analog to digital. In embodiments, the components performing analog to digital conversion are instead part of optical sensor 151 and optical sensor 155. Memory 170 stores processed signal 172.

Memory 170 includes software 180. Software 180 includes one or both of a fringe analyzer 182 and a signal-shape analyzer 184. Each of fringe analyzer 182 and signal-shape analyzer 184 includes respective machine-readable instructions that are executable by processor 164 to perform functions of optical flame-sensor 100 as described herein. When executed by processor 164, fringe analyzer 182 controls processor 164 to analyze processed signal 172 to determine whether optical-fiber cavity 130 is heating or cooling according to temporal changes in interference fringes of processed signal 172. When executed by processor 164, signal-shape analyzer 184 controls processor 164 to determine a temperature or temperature range of optical-fiber cavity 130.

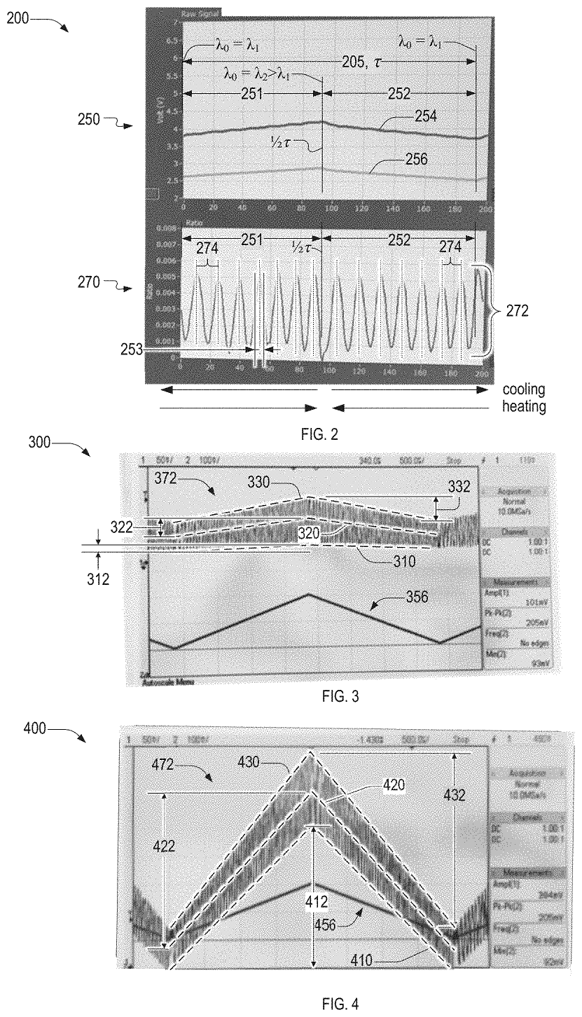

FIG. 2 includes plots 250 and 270, each of which illustrate data measured by an embodiment of optical flame-sensor 100. In the embodiment, time-varying voltage 104 is a 1-kHz sawtooth waveform, laser 110 is a distributed feedback laser with a center wavelength λ₀=1550 nm. The fiber-optic coupler functions as a 90:10 splitter, where 90:10 is the power ratio of optical signal 112 to reference optical signal 116. Optical fiber 135 has a length of 1.0±0.1 meters, mirror 140 has a fifty-percent reflectivity, and reflectance 132 is approximately four percent. In embodiments, mirror 140 has reflectivity between 45% and 55% at center wavelength λ₀.

Plot 250 displays a cavity voltage 254 and a reference voltage 256, which are examples of cavity electrical signal 154, and reference electrical signal 156, respectively. Plot 250 denotes time intervals 251 and 252. Time intervals 251 and 252 span modulation period 205 (herein also referred to as τ), of time-varying voltage 104. FIG. 2 denotes a time τ/2, which denotes the end of time interval 251 and the beginning of time interval 252. Modulation period 205 is an example of modulation period 105.

Time-varying voltage 104 applied to laser 110 modulates both the wavelength and power of optical signal 111 such that center wavelength λ₀ and voltages 254 and 256 increase during time interval 251 and decrease during time interval 252. For example, the center wavelength λ₀ of optical signal 111 may increase from λ₁ at the start of time interval 251 to λ₂ at time τ/2, and decrease back to λ₁ at the end of time interval 252.

Plot 270 includes a fringe signal 272, which is cavity voltage 254 normalized by reference voltage 256 and is an example of processed signal 172. Fringe signal 272 includes a plurality of interference maxima occurring at resonance times 274, which correspond to when laser 110 is tuned to a resonance wavelength λₘ of optical-fiber cavity 130. Vertical dotted lines denote each resonance time 274. For clarity of illustration, not all resonance times 274 are labelled with a reference numeral.

When the temperature of optical-fiber cavity 130 is unchanging, resonance times 274 are stationary over time, for example, between consecutive modulation periods 205 (τ). Each resonance time 274 of time interval 251 corresponds to a respective mode number m and corresponding wavelength τₘ that satisfies λₘ=n₁ (T)L(T)/2m, where n₁(T) and L(T) are, respectively, the temperature-dependent refractive index and temperature dependent length of optical-fiber cavity 130. When the temperature of optical-fiber cavity 130 increases, the product n₁(T)L(T) increases such that each λₘ also increases, which means that the resonance times 274 corresponding to when laser 110 emits resonance wavelength λₘ also increases. Hence, when comparing fringe signal 272 for consecutive modulation periods 205 when optical-fiber cavity 130 is heating, each resonance time 274 within time interval 251 moves toward time τ/2. Similarly, each resonance time 274 within time interval 252 moves toward time τ/2 because center wavelength λ₀ decreases from λ₂ to λ₁ during time interval 252.

Cooling optical-fiber cavity 130 has the opposite effect on resonance times 274. When optical-fiber cavity 130 is cooling, resonance times 274 within time intervals 251 and 252 move away from time τ/2.

In embodiments, fringe analyzer 182 determines the aforementioned movement, or temporal drift, of resonance times 274 and therefrom generate a temperature-change status 176 stored in memory 170. Signal 169 may include temperature-change status 176. Temperature-change status 176 may be a binary indication of whether flame 194 is present. In other words, when fringe analyzer 182 determines that the optical-fiber cavity 130 is heating, flame 194 must be present and thus temperature-change status 176 indicates flame-presence or heating. Conversely, when fringe analyzer 182 determines that optical-fiber cavity 130 is cooling, flame 194 is absent and thus temperature-change status 176 indicates flame-absence or cooling. In embodiments, temperature-change status 176 indicates one of three states: heating, cooling, and steady-state temperature. Alternate or additional techniques for determining temporal drifts of resonance times 274 include fringe-counting, cross-correlation, and phase-retrieval methods.

In embodiments, fringe analyzer 182 alternatively or additionally determines temperature-change status 176 and/or a measured temperature 178 by counting fringes within time intervals 251 and 252. When optical-fiber cavity 130 is heating, its length increases such that its free-spectral range decreases, which results in more closely-spaced resonance times 274, and hence more resonance times 274 (that is, more fringes) within time intervals 251 and 252. The opposite holds when optical-fiber cavity 130 is cooling. Memory 170 may store calibration data 174. In embodiments, calibration data 174 includes fringe counts as a function of temperature, as a look-up table for example, such that flame-sensor processor 160 can map the number fringes in time intervals 251 and/or 252, as counted by fringe analyzer 182, to a temperature of calibration data 174. Measured temperature 178 may denote a specific temperature value, a range of temperature values, or be a binary indicator indicating “hot” or “cold” status of burner 185. In embodiments, “hot” denotes when the measured temperature exceeds an upper-threshold temperature, such as 500° C., and “cold” denotes when the measured temperature is less than a lower-threshold temperature, such as 100° C.

In embodiments, a fringe is defined by a data point in processes signal 172 that has a value exceeding (or less than) each signal value of a predetermined number of data points. The predetermined number equals ten, for example. To prevent double counting of a single fringe, only one of two temporally consecutive points qualify as fringe, in embodiments. In embodiments, fringe analyzer 182 determines a fringe count as an average number of fringes counted in a plurality of modulation periods 105. In embodiments, fringe analyzer 182 applies a low-pass filter to processed signal 172, with a cut-off frequency of 100 kHz for example, to remove noise that can result in inaccurate fringe counts.

In an embodiment, optical fiber cavity 130 is thirty centimeters long and the core of optical fiber 135 has refractive indices n_{c}=1.446 and nₕ=1.45354 at temperatures 25° C. and 700° C. respectively. In this embodiment, optical fiber cavity 130 has a free-spectral range (fringe spacing) of 2.10 picometers at 25° C. and 2.09 picometers at 700° C. When signal generator 102 modulates the center wavelength λ₀ of laser 110 over a scan range of approximately 700 picometers, the difference in counted fringes is 1.65 fringes between 25° C. and 700° C. This difference is discernable when averaging fringe counts over multiple scans.

In embodiments, fringe analyzer 182 determines measured temperature 178 by counting the number of data points between a predetermined fringe number and a “turn-around” point when the center wavelength λ₀ of laser 110 equals its maxim value λ₂ before decreasing back to its minimum value λ₁. See time τ/2 in FIG. 2 when time interval 251 ends and time interval 252 begins, for example. As optical fiber cavity 130 heats, the number of fringes between the turn-around point increases such that the number of data points between the turn-around point and the predetermined fringe decreases. Similarly, as optical fiber cavity 130 cools, the number of fringes between the turn-around point decreases such that the number of data points between the turn-around point and the predetermined fringe increases.

In embodiments including a cross-correlation method, fringe analyzer 182 alternatively or additionally determines temperature-change status 176 by determining a respective cross-correlation of temporally consecutive fringe signals 272(1, 2, . . . ) corresponding to temporally consecutive modulation periods 205(1, 2, . . . ). The cross-correlations produce a time series of respective correlation maxima corresponding to a times {t₁, t₂, . . . } relative to the start of a modulation period 205. Heating of optical-fiber cavity 130 corresponds to when times {t₁, t₂, . . . } are monotonically increasing during time interval 251 and monotonically decreasing during time interval 252. Cooling of optical-fiber cavity 130 corresponds to when times {t₁, t₂, . . . } are monotonically decreasing during time interval 251 and monotonically increasing during time interval 252.

In embodiments, fringe analyzer 182 alternatively or additionally determines temperature-change status 176 by applying a phase-retrieval technique to consecutive fringe signals 272(1, 2, . . . ) and compare resultant phases {ϕ₁, ϕ₂, . . . } to determine temporal drift of resonance times 274. The phase-retrieval technique may include applying a Fourier transform to temporally consecutive fringe signals 272(1, 2, . . . ), which yields a complex frequency-domain signal (including a real and imaginary part), and computing resultant phases {ϕ₁, ϕ₂, . . . } therefrom. Per the Fourier shift theorem, signals that differ by a phase in the frequency domain and shifted in time relative to each other in the time domain.

Hence, in embodiments, fringe analyzer 182 updates temperature-change status 176 when resultant phases {ϕ₁, ϕ₂, . . . } are consistently increasing or decreasing in time. Fringe analyzer 182 evaluate signs of phase differences sgn(Δϕᵢ), where Δϕᵢ=ϕᵢ−ϕᵢ₋₁. In embodiments, fringe analyzer 182 updates temperature-change status 176 when the sum of sgn(Δϕᵢ) for a predetermined number of consecutive periods N exceeds a positive threshold or is less than a negative threshold. For example, when N=25, the absolute value of the positive threshold and negative threshold may each equal ten. When the sum of sgn(Δϕᵢ) is between the positive and negative thresholds, fringe analyzer 182 may output a temperature-change status 176 indicating a steady-state temperature.

In embodiments, fringe analyzer 182 updates temperature-change status 176 when a cumulative phase difference ΣΔϕᵢ over a predetermined number of periods (consecutive or non-consecutive periods) N exceeds a positive threshold or is less than a negative threshold. For example, a positive cumulative phase difference denotes cooling and a negative cumulative phase difference denotes heating.

In embodiments, the phase-retrieval technique may include pre-processing temporally consecutive fringe signals 272 to remove temporal frequencies unrelated to a frequency of interest, such as temporal spacings between consecutive resonance times 274.

In embodiments, fringe analyzer 182 alternatively or additionally determines temperature-change status 176 using a “binary-data transition-tracking” technique, which includes comparing, for N consecutive modulation periods {P₁, P₂, . . . , P_{N}} each having a duration i (modulation period 205 for example), M samples {S₁, S₂, . . . , S_{M}} of fringe signal 272 within a temporal segment Δt, which may be less than a temporal spacing between adjacent resonance times 274 for tracking a resonance time 274 corresponding to a single mode number m. Sample-count M may exceed consecutive-period-count N.

FIG. 2 denotes a temporal segment 253, which is an example of temporal segment Δt. The start and stop times defining temporal segment Δt are constant relative to the beginning and end of modulation period τ, such that temporal segment Δt corresponds to the same wavelength range of optical signal 112 during each modulation period P. Samples {S₁, S₂, . . . , S_{M}} occur in chronological order within temporal segment Δt. N and M equal six and three respectively in the following example. Also in the following example, sample {S₁, S₂, . . . , S_{M}}ᵢ corresponds to modulation period Pᵢ, where integer i ranges from 1 to N.

In embodiments, fringe analyzer 182 alternatively or additionally determines temperature-change status 176 by applying a signum function to each sample {S₁, S₂, . . . , S_{M}}ᵢ. The signum function yields a binary data sample Bᵢ={B₁, B₂, . . . , B_{M}}ᵢ, where each sample value B is one of two values, such as {0, +1} or {−1, +1}. Fringe analyzer 182 determines a temporal trend of transition times when temporally-consecutive sample values B changes from the one value to another, e.g., from zero to one or vice versa, or a sign change. The direction of this temporal trend—forward or backward in time—indicates the direction of resonance times 274, and hence whether optical-fiber cavity 130 is heating or cooling. Absence of a temporal trend, e.g., the transition times exhibit a temporal jitter, indicates a steady-state temperature.

In embodiments, fringe analyzer 182 updates temperature-change status 176 when the temporal trend persists in a same direction for a time that exceeds a threshold time. In embodiments threshold time is a multiple of modulation period 105, where the multiple is between five and ten.

For example, fringe analyzer 182 may generate consecutive samples {+1, +1, +1}₁, {−1, +1, +1}₂, {−1, −1, +1}₃, {−1, −1, −1}₄, {+1, −1, −1}₅, and {+1, +1, −}₆. In the samples, the temporal position of the sign change shifts from the earlier time to a later time, which indicates that resonance times 274 are shifting forward in time. When temporal segment Δt is within time interval 251, such a temporal shift means that optical-fiber cavity 130 is heating. When temporal segment Δt is within time interval 252, such a temporal shift means that optical-fiber cavity 130 is cooling. In embodiments, after analyzing the M samples an N modulation periods, fiber movement analyzer records the result (whether cavity 130 is heating or cooling) as temperature-change status 176.

Memory 170 may also include a temperature-change history 177, which includes a time series of previously-measured temperature-change statuses 176, each of which may be paired with a respective time stamps. In embodiments, temperature-change history 177 enables determination of whether optical-fiber cavity 130 is “hot” (near flame 194, e.g., T>500° C.) or “cold” (flame 194 is absent, e.g., T<100 ° C.) even after optical-fiber cavity 130 has reached a temperature equilibrium such that its temperature is not changing with time. When memory 170 is a non-volatile memory, temperature-change history 177 may be useful in the event of a power outage or a reboot of flame-sensor processor 160.

In embodiments, software 180 additionally or alternatively determines whether optical-fiber cavity 130, at a steady-state temperature, is hot or cold by quantifying temporal jitter in fringe signal 272, which increases as temperature increases. For example, fringe signal 272 includes higher frequencies when optical-fiber cavity 130 is hot, as compared to cold, such that software 180 may evaluate a frequency spectrum of fringe signal 272.

FIG. 3 includes a plot 300 illustrating data measured by another embodiment of optical flame-sensor 100. This embodiment of FIG. 3 is the same as the embodiment of FIG. 2, except that the reflectivity of mirror 140 is eight percent. Plot 300 includes a reference voltage 356 and a fringe signal 372, which are respective examples of reference electrical signal 156 and processed signal 172. Plot 300 includes a lower curve 310 and an upper curve 330. Lower curve 310 may be a linear fit of local minima of fringe signal 372. Upper curve 330 may be linear fit of local maxima of fringe signal 372. Plot 300 also includes a median curve 320, which may be an average of curves 310 and 330, or may result from applying a low-pass filter to fringe signal 372 to remove resonance fringes. Curves 310, 320, and 330 have respective fringe-signal amplitudes 312, 322, and 332 between their respective maxima and minima, each of which depends on the reflectivity of mirror 140, as illustrated in FIG. 4.

FIG. 4 includes a plot 400 illustrating data measured by another embodiment of optical flame-sensor 100. The embodiment of FIG. 4 is the same as the embodiment of FIG. 2, except that mirror 140 includes layer 142 that has fifty-percent reflectivity. Plot 400 includes a reference voltage 456 a fringe signal 472, which are respective examples of reference electrical signal 156 and processed signal 172. Plot 400 includes a lower curve 410, a median curve 420, and an upper curve 430 derived from fringe signal 472. Curves 410, 420, and 430 are analogous to curves 310, 320, and 330 of FIG. 3, respectively. Curves 410, 420, and 430 have respective fringe-signal amplitudes 412, 422, and 432, which are analogous to and greater than fringe-signal amplitudes 312, 322, and 332 of FIG. 3, respectively. In embodiments, calibration data 174 stores the temperature dependence of at least one of the aforementioned fringe-signal amplitudes such that flame-sensor processor 160 determines measured temperature 178 by comparing measured fringe-signal amplitudes to those stored in calibration data 174.

FIGS. 3 and 4 illustrate the relationship, well known per the physics of Fabry-Perot optical cavities, that fringe-signal amplitudes associated with fringe signals increase as reflectivity of mirror 140 increases. Neither of fringe signal 372 and fringe signal 472 is normalized by a reference voltage, e.g., reference electrical signal 156. Given a temperature dependent reflectivity of mirror 140, optical-fiber cavity 130 may be calibrated such that its temperature is derivable from processed signal 172, for example, via one of the curves and/or fringe-signal amplitudes of FIGS. 3 and 4. Temperature-dependent reflectivity of mirror 140 (or equivalents, e.g., a normalized temperature-dependent reflectivity or fringe-signal amplitudes such as those of FIGS. 3 and 4) may be an injective (“one-to-one”) function between temperatures T₁ and T₂, such that each reflectivity value maps to one, and only one, temperature in the range spanning T₁ and T₂. Memory 170 may store such a function as calibration data 174, which may be a look-up table.

In embodiments, optical flame-sensor 100 is configured such that processed signal 172 resembles median curves 320 and 420, which enables determination of the temperature of optical-fiber cavity 130. In such embodiments, hereinafter a “nominal cavity” embodiment, optical-fiber cavity 130 is optically coupled to second port 122, via fiber distal-end 126 for example, such that reflectance 132 is sufficiently low that optical-fiber cavity 130 is only nominally a cavity, and functions as a fiber-optic mirror. For example, fiber distal-end 126 and cavity proximal-end 131 may be optically coupled such that reflectance 132 is less than 0.1 percent (−30 dB).

In embodiments, mirror 140 includes layer 142 that has a temperature dependent reflectivity that ranges from between a maximum and a minimum (of visa versa) between aforementioned temperature T₁ (the “no flame” temperature) and a second temperature T₂, which may exceed T₁ by at least five-hundred Kelvin. For example, at center wavelength λ₀ and first temperature T₁, layer 142 may have a refractive index n_{R1} and a thickness L₁=¼λ₀/4n_{R1} (2q₁+1) where q₁ is a non-negative integer such that layer 142 functions as a quarter-wave reflective coating (a multiple-order coating, order equals q₁). At center wavelength λ₀ and second temperature T₂, layer 142 may have a refractive index n_{R2} and thickness L₂=½λ₀/n_{R2} (2q₂+1) where q₂ is a non-negative integer such that layer 142 functions as a half-wave antireflective coating (a multiple-order coating, order equals q₂). In embodiments, q₁=2q₂ such that (L₂−L₁)≅λ₀/4n̅, where n̅ is the mean of n_{R1} and n_{R2} , which results inlayer 142 having a one-to-one mapping of temperature to reflectivity between T₁ and T₂.

Thicknesses L₁ and L₂ refer to distances between a top surface 143 and a bottom surface 144 of layer 142, which may be planar and parallel to each other. Given a material of layer 142, its thermal expansion coefficient and temperature-dependent refractive index may be used in the above expressions for lengths L₁ and L₂ to find values of positive integers q₁ and q₂ such that both expressions are satisfied at their respective temperatures T₁ and T₂. Integers q₁ and q₂ may be equal. When both q₁ and q₂ equal zero, or more generally when q₁=2q₂, layer 142 has the aforementioned one-to-one mapping of temperature to reflectivity.

An advantageous value for thickness L₁ may be found numerically or analytically. Thickness L₁ corresponds to the thickness of layer 142 at temperature T₁, the “no flame” temperature, and hence is representative of the temperature at which layer 142 is fabricated. For example, given the thermal expansion coefficient and temperature-dependent refractive index of layer 142, its reflectivity R as a function of corresponding thicknesses L₁ and L₂ can be determined (i) at temperature T₁ to yield R₁(L₁) and (ii) at temperature T₂ to yield R₂(L₂). Each of R₁(L₁) and R₂(L₂) are periodic functions of thickness L_{1,2}, as the layer transitions between being a multiple-order quarter-wave reflector and multiple-order half-wave antireflective coating.

An advantageous value for thickness L₁ may be found by first converting R₂(L₂) to R₂(L₁) by mapping the R₂ values to a range of L₁ values (thicknesses at temperature T₁) by using the thermal expansion coefficient of the material of layer 142 to convert the range of L₂ values (thicknesses at temperature T₂) to a range of L₁ values. A difference between R₂(L₁) and R₁(L₁), |R₂(L₁)−R₂(L₁)| for example, yields a difference in reflectivity ΔR(L₁) of layer 142, between temperatures T₁ and T₂, as a function of candidate thicknesses L₁ at temperature T₁. Thicknesses L₁ corresponding to local maxima of ΔR(L₁) are advantageous values for thickness L₁.

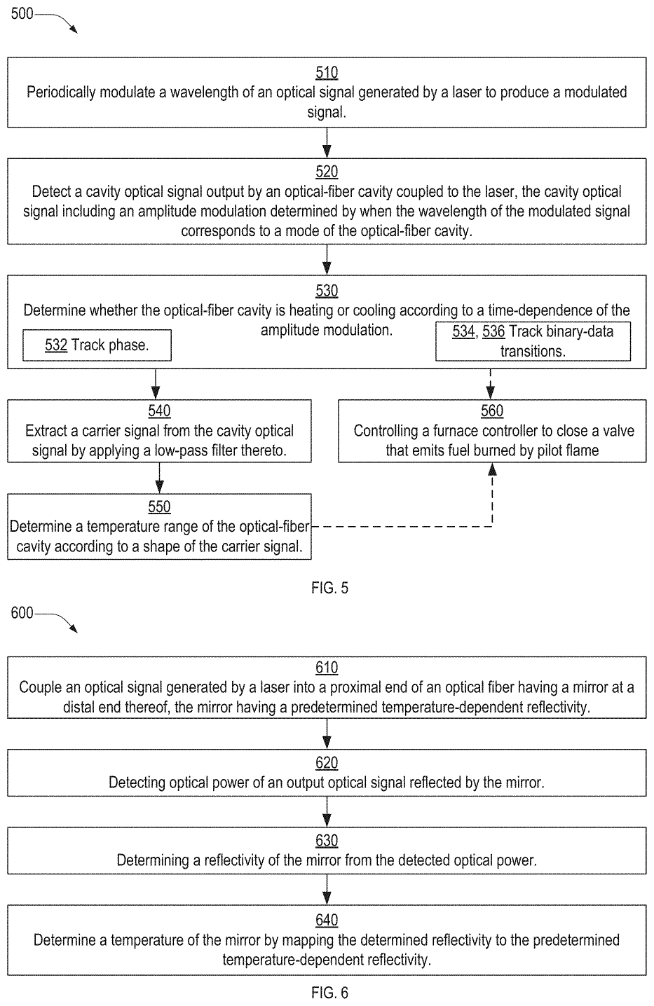

FIG. 5 is a flowchart illustrating a method 500 for detecting presence of a flame. Method 500 may be implemented within one or more aspects of optical flame-sensor 100. Method 500 may be implemented by processor 164 executing computer-readable instructions of software 180. Method 500 includes at least one of steps 510, 520, 530, 540, 550, and 560.

Step 510 includes periodically modulating a wavelength of an optical signal generated by a laser to produce a modulated signal. In an example of step 510, signal generator 102 periodically modulates center wavelength λ₀ of optical signal 111 generated by laser 110.

Step 520 includes detecting a cavity optical signal output by an optical-fiber cavity coupled to the laser. The cavity optical signal includes an amplitude modulation determined by when the wavelength of the modulated signal corresponds to a mode of the optical-fiber cavity. In an example of step 520, optical sensor 151 detects cavity output signal 114.

Step 530 includes determining whether the optical-fiber cavity is heating or cooling according to a time-dependence of the amplitude modulation. In a first example of step 530, fringe analyzer 182 determines whether the optical-fiber cavity 130 is heating or cooling according to a time-dependence of one or more resonance times 274, FIG. 2. In a second example of step 530, fringe analyzer 182 determines whether the optical-fiber cavity 130 is heating or cooling by counting the number of resonances (each occurring at a specific resonance time 274) during one or both of time intervals 251 and 252, and matching the counted number of resonances to a temperature stored in calibration data 174.

Step 530 may include at least one of the aforementioned techniques: fringe-counting, cross-correlation, phase-retrieval, and binary-data transition-tracking. In embodiments, step 530 includes step 532, which includes tracking a phase of a frequency-domain representation of the amplitude modulation. In an example of step 532, fringe analyzer 182 applies a Fourier transform to fringe signal 272 and tracks time dependence of a phase of the resultant frequency-domain signal.

In embodiments, step 530 includes steps 534 and 536. Step 534 includes converting the amplitude modulation to a binary time-series. In an example of step 534, fringe analyzer 182 converts fringe signal 182 to a binary time-series that includes the aforementioned binary data sample {B₁, B₂, . . . , B_{M}}ᵢ, where sample values B_{1-M} span temporal segment Δt.

Step 536 includes tracking, during a time-interval of the binary time-series not exceeding a time duration between consecutive modes of the optical-fiber cavity, when the binary time-series transitions from a first discrete value and a second discrete value. In embodiments, time-varying voltage 104 determines the time duration between the presence of consecutive modes resonating within optical-fiber cavity 130. In an example of step 536, fringe analyzer 182 determines a temporal trend of transition times when temporally-consecutive sample values B changes from a first discrete value (e.g., 0) to a second discrete value (e.g., 1).

Step 540 includes extracting a carrier signal from the cavity optical signal by applying a low-pass filter thereto. In a first example of step 540, signal-shape analyzer 184 applies a low-pass filter to fringe signal 372 to yield median curve 320. In a second example of step 540, signal-shape analyzer 184 applies a low-pass filter to fringe signal 472 to yield median curve 420.

Step 550 includes determining a temperature range of the optical-fiber cavity according to a shape of the carrier signal. In a first example of step, signal-shape analyzer 184 determines a temperature range of optical-fiber cavity 130 from fringe-signal amplitude 322 and calibration data 174. In a second example of step 550, signal-shape analyzer 184 determines a temperature or a temperature range of optical-fiber cavity 130 from fringe-signal amplitude 422 and calibration data 174. Signal-shape analyzer 184 may output the temperature or temperature range as measured temperature 178, which may be part of signal 169.

Method 500 may include step 560 when the optical-fiber cavity is proximate a pilot tip of a furnace burner controlled by a furnace controller. Step 560 includes, when the optical-fiber cavity is cooling and/or has a temperature less than a predetermined threshold temperature, one or both of generating a warning signal and controlling the furnace controller to close a valve that emits fuel burned by the pilot flame. In an example of step 560, optical-fiber cavity 130 is proximate pilot tip 193. Fringe analyzer 182 determines that optical-fiber cavity 130 is cooling (via step 530) and/or has a temperature less than a predetermined threshold temperature (via step 550), and in response to receiving signal 169 from flame-sensor processor 160, furnace controller 181 generates a warning signal and/or closes gas valve 192. Furnace controller 181 may display the warning signal on display 183.

FIG. 6 is a flowchart illustrating a method 600 for detecting presence of a flame. Method 600 may be implemented within one or more aspects of optical flame-sensor 100, such as one of the aforementioned “nominal cavity” embodiments of optical flame-sensor 100. Method 600 may be implemented by processor 164 executing computer-readable instructions of software 180. Method 600 includes at least one of steps 610, 620, 630, and 640.

Step 610 includes coupling an optical signal generated by a laser into a proximal end of an optical fiber having a mirror at a distal end thereof, the mirror having a predetermined temperature-dependent reflectivity. In an example of step 610, optical circulator 120 couples optical signal 112 into optical-fiber cavity 130, which includes layer 142 having a predetermined temperature-dependent reflectivity stored as calibration data 174.

Step 620 includes detecting optical power of an output optical signal reflected by the mirror. In an example of step 620, optical sensor 151 detects cavity output signal 114. Step 620 may also include detecting optical power of a reference optical signal. For example, step 620 may include detecting reference optical signal 116 with optical sensor 155.

Step 630 includes determining a reflectivity of the mirror from the detected optical power. In an example of step 630, signal shape analyzer 184 determines a reflectivity of layer 142 from cavity electrical signal 154 and reference electrical signal 156 via processed signal 172. In embodiments, processed signal 172 is cavity electrical signal 154 divided by reference electrical signal 156, such that the amplitude of processed signal 172, or a time-average thereof, corresponds to, or equals, the reflectivity of layer 142.

Step 640 includes determining a temperature of the mirror by mapping the determined reflectivity to the predetermined temperature-dependent reflectivity. In an example of step 640, signal-shape analyzer 184 determines the temperature of layer 142 by mapping the amplitude of processed signal 172 to a temperature using calibration data 174.

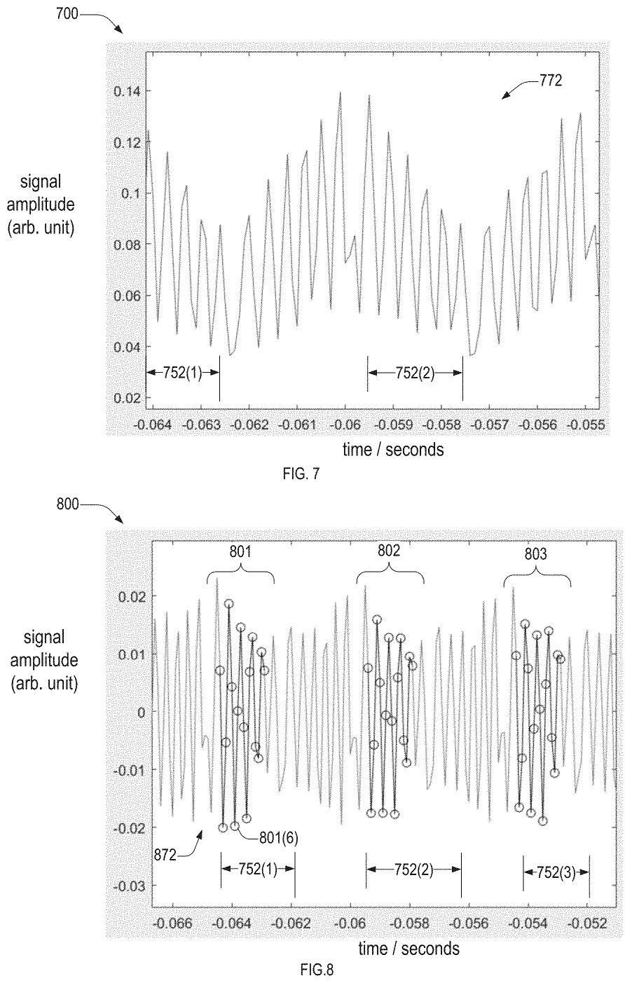

FIGS. 7-9 are graphical representations of measured signals and processed signals illustrating steps of the aforementioned binary-data transition-tracking technique implemented by an embodiment of flame-sensor processor 160 for determining temperature-change status 176. FIG. 7 includes a graph 700 that depicts a signal 772, which is an example of processed signal 172, FIG. 1, generated by an embodiment of optical flame-sensor 100. In this embodiment, time-varying voltage 104 is a 50-mV 200-Hz sawtooth waveform, and electronics 162 samples cavity electrical signal 154 at 10 kHz. The amplitude of signal 772 is modulated by time-varying voltage 104 and has a plurality of cavity-resonance modulations within each period of time-varying voltage 104 corresponding to resonances of optical fiber cavity 130. Graph 700 includes sample intervals 752(1) and 752(2) during which the amplitude of time-varying voltage 104 is decreasing. Sample intervals 752 are hence examples of time interval 252, FIG. 2, during which center wavelength λ₀ is decreasing.

FIG. 8 includes a graph 800 that depicts a filtered signal 872, which results from flame-sensor processor 160 (a) demodulating signal 772 to remove the amplitude modulation imparted by time-varying voltage 104, and (b) applying a bandpass filter to signal 772. The bandpass filter has a passband centered at a frequency corresponding to the cavity-resonance modulations. Filtered signal 872 includes sampled data 801-802, denoted by open circles, measured during sample intervals 752(1) and 752(2) respectively. Filtered signal 872 also includes sampled data 803, also denoted by open circles, measured during a sample interval 752 that occurs consecutively after sample interval 752(2).

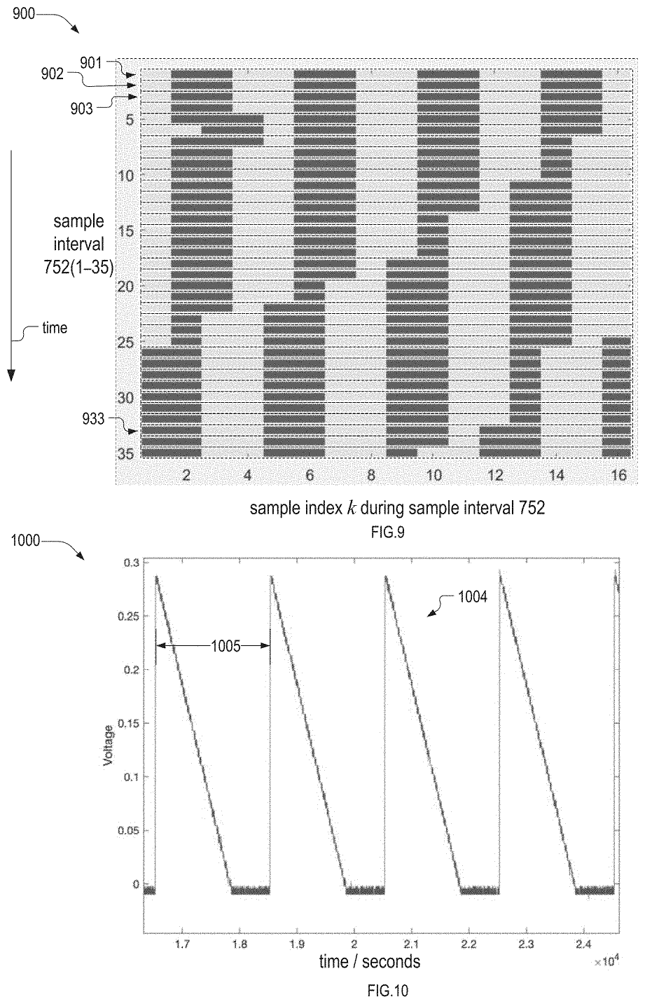

Signal generator 102 may be communicatively coupled to flame-sensor processor 160 enables fringe movement analyzer 182 to use time-varying voltage 104 as a trigger for selecting sampled data 801 and 802. Each of sampled data 801-803 include sixteen data points. For sample data 801, data point 801(k) is the k^{th} data point of sampled data 801, where k is a sample index that ranges from one to sixteen. For example, FIG. 8 denotes a data point 801(6) is the sixth data point of sampled data 801. Fringe analyzer 182 may apply a signum function to sampled data 801-803, e.g., in steps 534 and 536 of method 500, FIG. 5, which results in binary sampled data 901-903 shown in FIG. 9. Binary sampled data 901-903 are each examples of a respective binary data sample Bᵢ={B₁, B₂, . . . , B_{M}}ᵢ in the above discussion of the binary-data transition-tracking technique.

Binary sampled data 901-903 are the first three rows of a data array 900, shown in FIG. 9 as a pseudocolor plot. Data array 900 includes thirty-five rows and sixteen columns. Each of the thirty-five rows corresponds to a respective sample interval 752(1-35), of which sample intervals 752(1-3) are shown in FIG. 8. Sample intervals 752(1-35) correspond to thirty-five consecutive periods of time-varying voltage 104. Fringe analyzer 182 generates the remaining rows of data array 900, rows four to thirty-five, to sampled data 804-835, not shown in FIG. 8, to generate binary sampled data 904-935. For clarity of illustration, FIG. 9 does not include a reference numeral for each of binary sampled data 904-935. In FIG. 9, dark regions of each binary sampled data 901-935 indicate a zero, while light regions indicate a one.

It can be seen in FIG. 9 that there is a leftward trend in time, that is, as index i of sample interval 752 increases from the top to bottom of data array 900 from one to thirty-five, the values of sample-index k corresponding to dark regions decrease. Recall that each sample interval 752 corresponds to when the amplitude of time-varying voltage 104 is decreasing, and hence center wavelength λ₀ is decreasing. The leftward trend indicates that the fringes, or resonance times 274 of FIG. 2, are shifting closer to the start of sample interval 752, which, per the discussion of FIG. 2, indicates heating of optical-fiber cavity 130.

In embodiments, fringe analyzer 182 evaluates a sub-array of data array 900, such as a plurality of columns corresponding to consecutive sample indices, and track a temporal trend of transition times as described in the discussion of the binary-data transition-tracking technique and steps 534,536 of method 500. For example, if the consecutive sample indices k range from four to six, then each of binary sampled data 901(4-6), 902(4-6), . . . , 935(4-6) is respective example of a binary data sample Bᵢ={B₄, B₅, B₆}ᵢ, where i ranges from one to thirty-five.

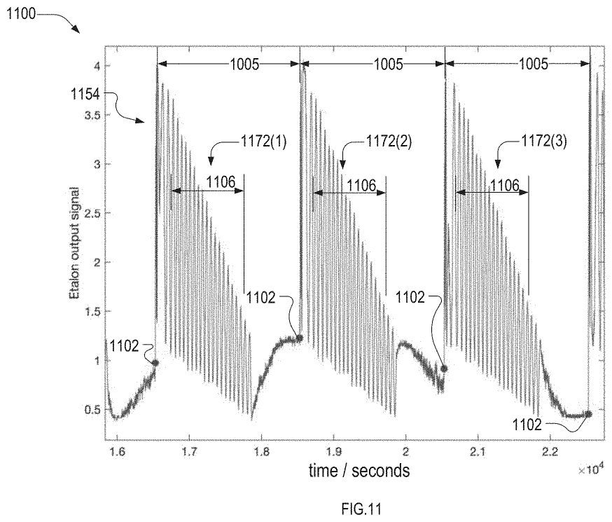

FIGS. 10 and 11 are graphical representations of measured signals illustrating example steps of the aforementioned phase-retrieval method implemented by flame-sensor processor 160 for determining temperature-change status 176.

FIG. 10 includes a graph 1000 that depicts a sawtooth voltage 1004, which is an example of time-varying voltage 104. Sawtooth voltage 1004 has a period 1005, which is an example of period 105. A half-sawtooth waveform simplifies parts of software 180 required for triggering, that is, detecting a start of consecutive modulation periods 105. In embodiments, software 180, as part of step 532, evaluates only cavity electrical signal 154, rather than also reference electrical signal 156, to determine the start of a new modulation period 105.

FIG. 11 includes a graph 1100 that depicts a cavity electrical signal 1154, which is an example of cavity electrical signal 154 and/or processed signal 172, FIG. 1. Graph 1100 includes trigger points 1102, which correspond to when the time-derivative of cavity electrical signal 1154 exceeds a threshold value. FIG. 11 denotes a sampling-intervals 1106 during each period 1005, which include consecutive signal segments 1172(1-3) of cavity electrical signal 1154. Each signal segment 1172 is an example of fringe signal 272 during time interval 252, during which center wavelength λ₀ is decreasing.

In embodiments, fringe analyzer 182 applies a Fourier transform to signal segments 1172(1, 2, 3, . . . ) and computes therefrom a respective phase {ϕ, ϕ₂, ϕ₃, . . . }₁₁₇₂. Phases {ϕ, ϕ₂, ϕ₃, . . . }₁₁₇₂ are examples of resultant phases {ϕ, ϕ₂, . . . } described in the aforementioned phase-retrieval technique. Before computing {ϕ, ϕ₂, ϕ₃, . . . }₁₁₇₂, fringe analyzer 182 may process signal segments 1172 to isolate a temporal frequency range corresponding to cavity resonances of optical-fiber cavity 130.

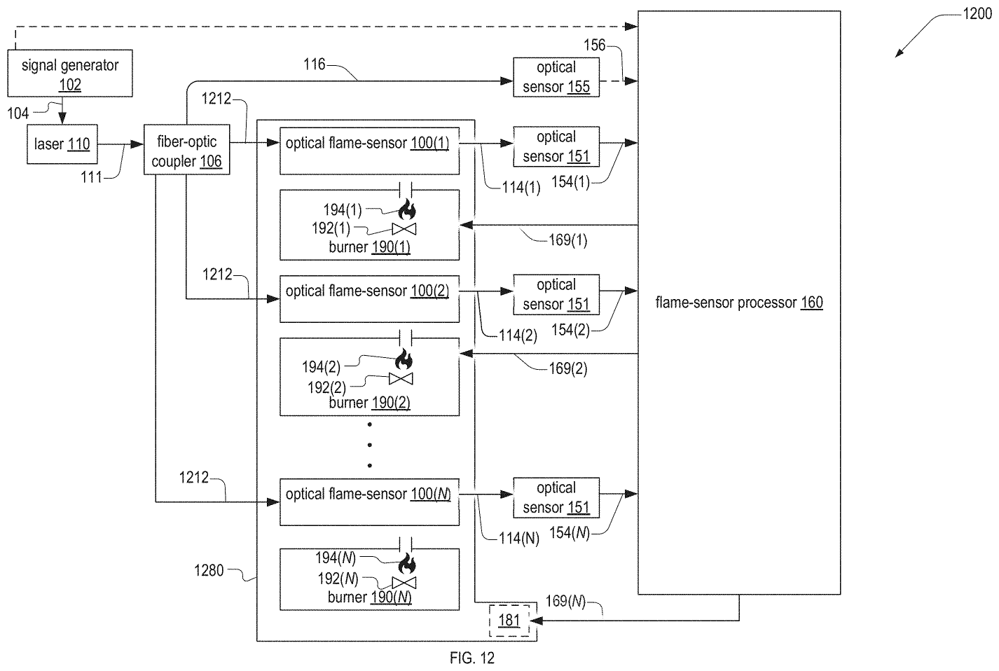

FIG. 12 is a schematic block diagram of a multichannel furnace-flame monitor 1200, which includes a plurality of optical flame-sensors 100(1, 2, . . ., N) each monitoring a respective flame 194(1, 2, . . ., N) associated with a burner 185(1, 2, . . ., N) of a furnace 1280. Furnace 1280 is an example of furnace 180, and may include furnace controller 181. Multichannel furnace-flame monitor 1200 also includes, N optical sensors 151, flame-sensor processor 160, and, in embodiments, optical sensor 155.

Integer N denotes the number of channels of multichannel furnace-flame monitor 1200. Herein, an element in the figures denoted by a reference numeral suffixed by a parenthetical numeral is an example of the element indicated by the reference numeral. For example, element optical flame-sensor 100(k) is an example (k) of optical flame-sensor 100, where index k is a positive integer in the range of 1 to N. Furnace 1280 may include multiple burners 190 such that burners 190(1, 2, . . . , N) refer to at most N distinct burners 190, and may refer to fewer than N distinct furnaces 180. For example, a burner 185(1) and burner 185(2) may be distinct burners within a to a same furnace 180

In embodiments, each optical flame-sensor 100 receives a respective optical signal 1212 generated by single laser 110, where fiber optic coupler 106 includes a beamsplitter, such as a fiber-optic splitter that splits optical signal 112 into at least N optical signals 1212. Using a single laser, laser 110, as a source for multiple optical flame-sensors 100 reduces the per-channel cost of multichannel furnace-flame monitor 1200.

Each optical sensor 151 receives a respective cavity output signal 114(k) from optical flame-sensor 100(k) and output a respective cavity electrical signal 154(k) to flame-sensor processor 160. From each cavity electrical signal 154(k), flame-sensor processor 160 produces a respective signal 169(k) received by furnace controller 181.

### Combinations of Features

Features described above as well as those claimed below may be combined in various ways without departing from the scope hereof. The following enumerated examples illustrate some possible, non-limiting combinations:

(A1) An optical flame-sensor includes an optical circulator, an optical-fiber cavity, and a first optical sensor. The optical circulator includes a first port, a second port, and a third port. The first port is configured to receive an optical signal. The second port is configured to output the optical signal received at the first port. The third port is configured to output the input to the second port. The optical-fiber cavity includes a cavity proximal-end optically coupled to the second port, and a mirror at a cavity distal-end, such that a cavity optical signal output by the optical-fiber cavity is the input to the second port. The first optical sensor is optically coupled to the third port and configured to quantify the cavity optical signal.

(A2) The optical flame-sensor of (A1) may further include a laser configured to generate the optical signal; and a signal generator electrically coupled to the laser and configured to apply a periodic waveform to the laser.

(A3) In any optical flame-sensor (A2), the laser may be a one of a distributed feedback laser, a distributed Bragg reflector laser, and a vertical-cavity surface-emitting laser configured to be tuned by the periodic waveform.

(A4) Any of optical flame-sensors (A2) and (A3) may include a plurality of the optical flame-sensors (A1)-(A3), each being configured to receive the optical signal at its respective first port.

(A5) In any of optical flame-sensors (A2)-(A4), the optical-fiber cavity may have, at the cavity proximal-end, a return loss between three and five percent.

(A6) Any of optical flame-sensors (A1)-(A5) may further include a first optical fiber optically coupling the optical-fiber cavity to the second port via a flat-polished optical-fiber connector.

(A7) In any of optical flame-sensors (A1)-(A6), the optical-fiber cavity may include a metalized optical fiber.

(A8) In any of optical flame-sensors (A1)-(A7), the optical-fiber cavity including an optical-fiber core formed of a first material having a refractive index n₁, the mirror may include a reflective surface formed of a second material having a refractive index n_{R}, (n_{R}−n₁)≥0.2.

(A9) In optical flame-sensor (A8), the second material may be selected from the group consisting of silicon, alumina, and zinc oxide.

(A10) Any of optical flame-sensors (A1)-(A9) may further include a reference optical sensor and a fiber-optic coupler. The fiber-optic coupler includes (i) a first coupler output optically coupling a first percentage of the optical signal to the first port, and (ii) second coupler output optically coupling a reference optical signal to the reference optical sensor. The reference optical signal is second percentage of the optical signal. the reference optical sensor is configured to quantify the reference optical signal. The first percentage exceeds the second percentage

(A11) Any of optical flame-sensors (A1)-(A10) may further include a processor; and a memory. The memory is configured to store the quantified cavity optical signal and machine-readable instructions that, when executed by the processor, control the processor to: analyze the quantified cavity optical signal to determine whether the optical-fiber cavity is heating or cooling according to at least one of (i) a temporal change in interference fringes of the cavity optical signal and (ii) a change in a number of detected interference fringes of the cavity optical signal during a modulation period of an optical signal.

(A12) In any of optical flame-sensors (A1)-(A11), in which the optical signal has a center wavelength λ₀; the mirror may have, at center wavelength λ₀, (i) a refractive index n₁ and thickness L₁ at a first temperature T₁ and (ii) a refractive index n₂ and thickness L₂ at a second temperature T₂, such that

$${L}_{1} = \frac{1}{4} \frac{{λ}_{0}}{{n}_{R 1}} ( 2 {q}_{1} + 1 ) and {L}_{2} = \frac{1}{2} \frac{{λ}_{0}}{{n}_{R 2}} ( 2 {q}_{2} + 1 ) ,$$

q₁ and q₂ being non-negative integers and |T₂−T₁|>500 K. The memory may further store machine-readable instructions that, when executed by the processor, control the processor to: extract a carrier signal from the quantified cavity optical signal by applying a low-pass filter thereto, and determine a temperature range of the optical-fiber cavity according to a shape of the carrier signal, determined in part by a temperature-dependent reflectivity of the mirror.

(A13) In any of optical flame-sensors (A1)-(A12), the optical-fiber cavity may include an optical fiber, the mirror being a distal end of the optical fiber that defines the cavity distal-end.

(A14) In any of optical flame-sensors (A1)-(A13), the mirror may have a reflectivity between 45% and 55% at a center wavelength λ₀ of the optical signal.

(A15) In any of optical flame-sensors (A1)-(A14), a center wavelength λ₀ of the optical signal may be between 1.2 μm and 1.70 μm.

(A16) In any of optical flame-sensors (A6)-(A15), a distal end of the first optical fiber may by optical coupled to a proximal end of the optical-fiber cavity. The distal end may have thereon a reflective coating that has a reflectance between forty and sixty percent at a center wavelength λ₀ of the optical signal.

(B1) An optical flame-sensor includes an optical-fiber cavity including (a) a cavity proximal-end configured to optically couple to (i) a laser and (ii) an optical sensor, (b) a cavity distal-end, and (c) a mirror at the cavity distal-end.The optical flame-sensor also includes a housing configured to mount the optical-fiber cavity to a flame-sensor port of a burner.

(B2) In any optical flame-sensor (B1), the housing may be configured to replace a flame rectification based flame sensor without modification to the burner.

(B3) In any optical flame-sensor (B1) or (B2), the optical-fiber cavity may have, at the cavity proximal-end, a return loss between three and five percent.

(B4) In any optical flame-sensor (B1)-(B3), the optical-fiber cavity may include a metalized optical fiber.

(B5) In any of optical flame-sensors (B1)-(B4), the optical-fiber cavity may include an optical-fiber core formed of a first material having a refractive index n₁, the mirror including a reflective surface formed of a second material having a refractive index n_{R}, (n_{R}−n₁)≥0.2.

(B6) In any of optical flame-sensors (B1)-(B5), the optical-fiber cavity may include an optical fiber, and the mirror may be a distal end of the optical fiber that defines the cavity distal-end.

(B7) In any of optical flame-sensors (B1)-(B6), the mirror may have a reflectivity between 45% and 55% at a center wavelength λ₀ of an optical signal output by the optical-fiber cavity.

(B8) In optical flame-sensor (B7), a center wavelength λ₀ of the optical signal may be between 1.2 μm and 1.70 μm.

(C1) A method for detecting presence of a flame includes: periodically modulating a wavelength of an optical signal generated by a laser to produce a modulated signal and detecting a cavity optical signal output by an optical-fiber cavity coupled to the laser. The cavity optical signal includes an amplitude modulation determined by when the wavelength of the modulated signal corresponds to a mode of the optical-fiber cavity. The method also includes determining whether the optical-fiber cavity is heating or cooling according to a time-dependence of the amplitude modulation.

(C2) Any method (C1) may further include extracting a carrier signal from the cavity optical signal by applying a low-pass filter thereto; and determining a temperature range of the optical-fiber cavity according to a shape of the carrier signal.

(C3) In any of methods (C1) and (C2), the step of determining may include tracking a phase of a frequency-domain representation of the amplitude modulation.

(C4) In any of methods (C1)-(C3), the step of determining may include: converting the amplitude modulation to a binary time-series; and tracking, during a time-interval of the binary time-series not exceeding a time duration between consecutive modes of the optical-fiber cavity, when the binary time-series transitions from a first discrete value and a second discrete value.

(C5) In any of methods (C1)-(C4), may further include, when (i) the optical-fiber cavity is proximate a pilot tip of a furnace burner and is (ii) at least one of (a) cooling and (b) has a temperature less than a predetermined threshold temperature, at least one of: closing a valve that emits fuel burned by the flame and generating a warning signal.

Changes may be made in the above methods and systems without departing from the scope hereof. It should thus be noted that the matter contained in the above description or shown in the accompanying drawings should be interpreted as illustrative and not in a limiting sense. Various embodiments described above may be combined in any manner, and certain individual features of each embodiment may or may not be included in such combinations. Herein, and unless otherwise indicated, the adjective “exemplary” means serving as an example, instance, or illustration. The following claims are intended to cover all generic and specific features described herein, as well as all statements of the scope of the present method and system, which, as a matter of language, might be said to fall therebetween.

What is claimed is:

1. An optical flame-sensor comprising:
an optical circulator including a first port, a second port, and a third port,
the first port configured to receive an optical signal,
the second port configured to output the optical signal received at the first port, and
the third port configured to output the input to the second port;
an optical-fiber cavity including a cavity proximal-end optically coupled to the second port, and a mirror at a cavity distal-end, such that a cavity optical signal output by the optical-fiber cavity is the input to the second port; and
a first optical sensor optically coupled to the third port and configured to quantify the cavity optical signal.

2. The optical flame-sensor of claim 1, further comprising:
a laser configured to generate the optical signal; and
a signal generator electrically coupled to the laser and configured to apply a periodic waveform to the laser.

3. The optical flame-sensor of claim 2, the laser being a distributed feedback laser configured to be tuned by the periodic waveform.

4. The optical flame-sensor of claim 2, further comprising a plurality of the optical flame-sensors of claim 1, each being configured to receive the optical signal at its respective first port.

5. The optical flame-sensor of claim 1, the optical-fiber cavity having, at the cavity proximal-end, a return loss between three and five percent.

6. The optical flame-sensor of claim 1, further comprising a first optical fiber optically coupling the optical-fiber cavity to the second port via a flat-polished optical-fiber connector.

7. The optical flame-sensor of claim 1, the optical-fiber cavity including a metalized optical fiber.

8. The optical flame-sensor of claim 1, the optical-fiber cavity including an optical-fiber core formed of a first material having a refractive index n₁, the mirror including a reflective surface formed of a second material having a refractive index n_{R}, (n_{R}−n₁)≥0.2.

9. The optical flame-sensor of claim 8, the second material being selected from the group consisting of silicon, alumina, and zinc oxide.

10. The optical flame-sensor of claim 1, further comprising:
a reference optical sensor; and
a fiber-optic coupler including (i) a first coupler output optically coupling a first percentage of the optical signal to the first port, and (ii) second coupler output optically coupling a reference optical signal to the reference optical sensor,
the reference optical signal being second percentage of the optical signal, the reference optical sensor being configured to quantify the reference optical signal, the first percentage exceeding the second percentage.

11. The optical flame-sensor of claim 1, further comprising:
a processor; and
a memory configured to store the quantified cavity optical signal and machine-readable instructions that, when executed by the processor, control the processor to:
analyze the quantified cavity optical signal to determine whether the optical-fiber cavity is heating or cooling according to at least one of (i) a temporal change in interference fringes of the cavity optical signal and (ii) a change in a number of detected interference fringes of the cavity optical signal during a modulation period of an optical signal.

12. The optical flame-sensor of claim 11,
the optical signal having a center wavelength λ₀;
the mirror having, at center wavelength λ₀, (i) a refractive index n₁ and thickness L₁ at a first temperature T₁ and (ii) a refractive index n₂ and thickness L₂ at a second temperature T₂, such that
$${L}_{1} = \frac{1}{4} \frac{{λ}_{0}}{{n}_{R 1}} ( 2 {q}_{1} + 1 ) and {L}_{2} = \frac{1}{2} \frac{{λ}_{0}}{{n}_{R 2}} ( 2 {q}_{2} + 1 ) ,$$
q₁ and q₂ being non-negative integers and |T₂−T₁|>500 K; and
the memory further storing machine-readable instructions that, when executed by the processor, control the processor to:
extract a carrier signal from the quantified cavity optical signal by applying a low-pass filter thereto, and
determine a temperature range of the optical-fiber cavity according to a shape of the carrier signal, determined in part by a temperature-dependent reflectivity of the mirror.

13. The optical flame-sensor of claim 1, the optical-fiber cavity including an optical fiber, the mirror being a distal end of the optical fiber that defines the cavity distal-end.

14. An optical flame-sensor comprising:
an optical-fiber cavity including
a cavity proximal-end configured to optically couple to (i) a laser and (ii) an optical sensor,
a cavity distal-end, and,
a mirror at the cavity distal-end; and
a housing configured to mount the optical-fiber cavity to a flame-sensor port of a burner.

15. The optical flame-sensor of claim 14, the housing configured to replace a flame rectification based flame sensor without modification to the burner.

16. A method for detecting presence of a flame comprising:
periodically modulating a wavelength of an optical signal generated by a laser to produce a modulated signal;
detecting a cavity optical signal output by an optical-fiber cavity coupled to the laser, the cavity optical signal including an amplitude modulation determined by when the wavelength of the modulated signal corresponds to a mode of the optical-fiber cavity; and
determining whether the optical-fiber cavity is heating or cooling according to a time-dependence of the amplitude modulation.

17. The method of claim 16, further comprising:
extracting a carrier signal from the cavity optical signal by applying a low-pass filter thereto; and
determining a temperature range of the optical-fiber cavity according to a shape of the carrier signal.

18. The method of claim 16, the step of determining comprising:
tracking a phase of a frequency-domain representation of the amplitude modulation.

19. The method of claim 16, the step of determining comprising:
converting the amplitude modulation to a binary time-series; and
tracking, during a time-interval of the binary time-series not exceeding a time duration between consecutive modes of the optical-fiber cavity, when the binary time-series transitions from a first discrete value and a second discrete value.

20. The method of claim 16, the optical-fiber cavity being proximate a pilot tip of a furnace burner, and further comprising, when the optical-fiber cavity is at least one of cooling and has a temperature less than a predetermined threshold temperature, at least one of: closing a valve that emits fuel burned by the flame and generating a warning signal.
